(19) United States
(12) Patent Application Publication
(10) Pub. No.: US 2022/0348144 A1
(43) Pub. Date: Nov. 3, 2022

(54) LUGGAGE HOLDING STRUCTURE, NET MEMBER FOR HOLDING LUGGAGE, AND LUGGAGE HOLDING METHOD

(71) Applicant: MAZDA MOTOR CORPORATION, Hiroshima (JP)

(72) Inventors: Keishi NISHIMURA, Hiroshima (JP); Ryosuke MORISHIGE, Hiroshima (JP); Shinya MATSUMOTO, Hiroshima (JP)

(73) Assignee: MAZDA MOTOR CORPORATION, Hiroshima (JP)

(21) Appl. No.: 17/725,083

(22) Filed: Apr. 20, 2022

(30) Foreign Application Priority Data
Apr. 30, 2021 (JP) 2021-077627

(51) Int. Cl. B60R 7/00

(52) U.S. Cl. CPC B60R 7/005

(57) ABSTRACT

A vehicle luggage holding structure has left and right first securing parts near a floor surface in a front section of a trunk, left and right second securing parts near the floor surface in a rear section, left and right third securing parts on an upper side relative to the floor surface at the middle in a front-rear direction, and left and right fourth securing parts below the third securing parts. To hold luggage, hanging parts of a net member are hooked onto the left and right first securing parts and on the left and right second securing parts. To partition the trunk in the front-rear direction, the net member is folded along a line connecting a pair of the hanging parts hooked onto the left and right third securing parts, and another pair of the hanging parts are hooked onto the left and right fourth securing parts.

### TECHNICAL FIELD

The present disclosure relates to a luggage holding structure, a net member for holding luggage, and a luggage holding method, and particularly relates to a luggage holding structure, a net member for holding luggage, and a luggage holding method in a trunk of a vehicle.

### BACKGROUND ART

Not only cargo automobiles, but also passenger automobiles often carry luggage, and travel. In a case where a vehicle travels in a state in which luggage is placed in a trunk of the vehicle, there is a possibility that the luggage will move in the trunk in accelerating and decelerating, changing the direction of the vehicle, or other cases, and cause damage to the luggage and the vehicle. There is a case where a net member for holding the luggage is used to restrain such a movement of the luggage when the vehicle is traveling.

As one example of a method for restraining the movement of luggage using the net member, there is a method in which hanging parts of the net member are hooked onto a plurality of securing parts provided on a floor surface of the trunk, and the luggage is pressed against the floor surface with the net member. Moreover, if the size of luggage is small, it may be possible to adopt a method in which the net member is folded in two and secured to the trunk such that the open side faces up, and the luggage is stored inside the net member folded in a bag shape (see, Japanese Patent Laid-Open No. 2019-217955).

### SUMMARY

One method for loading luggage in the trunk partitions the trunk in the front-rear direction, or the up-down direction, and loads the luggage. For example, in the case of vehicles such as a wagon type vehicle and a sport utility vehicle (SUV), an occupant riding in a rear seat may take out the luggage loaded in the trunk, or may take out the luggage by opening a rear gate after stopping the vehicle. In such a case, the trunk is partitioned in the front-rear direction so as to restrain the luggage loaded in the trunk from moving in the front-rear direction.

However, in conventional vehicles, it is necessary to load a partition member for partitioning the trunk in addition to a net member for securing luggage to the floor surface or the like of the trunk, resulting in a problem of an increase in the number of parts for holding the luggage in the vehicle.

The present disclosure has been made to solve the above-mentioned problem, and the disclosure provides a luggage holding structure that makes it possible to use a net member for securing luggage to a trunk of a vehicle as a partition member for the trunk, a net member for holding luggage, and a luggage holding method.

A luggage holding structure according to one aspect of the present disclosure is a luggage holding structure using a net member for restraining movement of luggage loaded in a trunk of a vehicle. The trunk of the vehicle has first securing parts, second securing parts, third securing parts, and fourth securing parts. The first securing parts are provided as a pair of left and right first securing parts near a floor surface in a front section of the trunk. The second securing parts are provided as a pair of left and right second securing parts near the floor surface in a rear section of the trunk. The third securing parts are provided as a pair of left and right third securing parts on the upper side relative to the first securing parts and the second securing parts in the trunk. The fourth securing parts are provided as a pair of left and right fourth securing parts on the lower side relative to the third securing parts in the trunk.

The net member is a planar member formed from a foldable material and having lengths in both of a first direction and a second direction orthogonal to the first direction, is expandable at least in the first direction of the first direction and the second direction, and has first hanging parts, second hanging parts, and third hanging parts. The first hanging parts are sections capable being hooked onto the first to the fourth securing parts, and are provided at one end in the first direction on both sides in the second direction. The second hanging parts are sections capable of being hooked onto the first to fourth securing parts, and are provided at another end in the first direction on both sides in the second direction. The third hanging parts are sections capable of being hooked onto the first to fourth securing parts, and are provided at a position between the one end and the other end in the first direction on both sides in the second direction.

Let L1 be a distance between the first securing part and the second securing part on each of left and right of the vehicle, L2 be a distance between the third securing part and the fourth securing part on each of left and right of the vehicle, L3 be a natural length between the first hanging part and the second hanging part in the first direction on each of both sides in the second direction of the net member, and L4 be a natural length between the third hanging part and the second hanging part in the first direction on each of both sides in the second direction of the net member. In this case, the net member is formed so as to satisfy both relations L3≤L1, and L4≤L2.

In the luggage holding structure according to the above aspect, the net member has the first hanging parts and the second hanging parts, and is configured to satisfy the relation L3≤L1. Therefore, in the luggage holding structure, by placing the net member to cover the luggage from the above in a state in which the luggage is loaded on the floor surface of the trunk, and hooking the first hanging parts and the second hanging part onto the first securing parts and the second securing parts, it is possible to prevent the luggage from moving when, for example, the vehicle is traveling.

Moreover, in the luggage holding structure according to the above aspect, the foldable material is used as the net member, and is configured to satisfy the relation L4≤L2. Therefore, with the luggage holding structure according to the above aspect, it is possible to partition the trunk into front and rear sections with the net member by folding the net member in two, hooking the third hanging parts onto the third securing parts, and hooking at least one of the first hanging parts and the second hanging parts onto the fourth securing parts.

Hence, with the luggage holding structure according to the above aspect, a single net member can be used for both the purpose of holding the luggage loaded on the floor surface, and the purpose of partitioning the trunk into the front and rear sections.

In the luggage holding structure according to the above aspect, the net member may be formed so as to be more easily expandable in the first direction compared to the second direction.

In the luggage holding structure according to the above aspect, the net member is formed so as to be more easily expandable in the first direction compared to the second direction along the vehicle width direction when the net member is attached to the trunk. In other words, the net member is formed so as not to expand easily in the second direction compared to the first direction. Therefore, in a case where the net member is folded in two and used as a partition member, the amount of expansion of the net member in the vehicle width direction can be made relatively small, which is preferred to make the net member reliably function as the partition member.

In the luggage holding structure according to the above aspect, the net member may have a rectangular shape in a plan view of the net member viewed from a direction orthogonal to both of the first direction and the second direction.

In the luggage holding structure according to the above aspect, the net member has a rectangular shape in the plan view, and therefore, even when the net member is folded in two, the net member is rectangular in shape. Hence, in the case where the net member is used as a partition member, it is possible to reduce occurrence of a gap between the net member and left and right trims enclosing the trunk.

In the luggage holding structure according to the above aspect, the net member may further have a shape retaining part oriented in the second direction to connect the third hanging parts to each other, and having a function for retaining a folded shape when the net member is folded along a line connecting the third hanging parts to each other.

In the luggage holding structure according to the above aspect, the net member has the shape retaining part, and, therefore, when the net member is folded in two and used as a partition member, it is less likely that the net member is deformed in shape and does not sufficiently function as the partition member.

In the luggage holding structure according to the above aspect, each of the first securing parts and the second securing parts may have a hook part in a hooked shape at a distal end portion, and each of the first hanging parts, the second hanging parts and the fourth securing parts may be formed in a ring shape capable of being hooked by the hook part.

In the luggage holding structure according to the above aspect, each of the first hanging parts and the second hanging parts has the hook part at the distal end portion, and each of the first securing parts, the second securing parts, and the fourth securing parts is formed in a ring shape, and therefore it is possible to secure the net member to the trunk by just hooking the hook parts onto the ring parts of the respective securing parts. Thus, in the luggage holding structure according to the above aspect, a user can secure the net member to the trunk by a simple operation.

In the luggage holding structure according to the above aspect, at least the distal end portion of each of the third hanging parts is formed in a ring shape, and each of the third securing parts is formed with a projection projecting upward so as to be able to be hooked by the third hanging part.

In the luggage holding structure according to the above aspect, at least the distal end portion of each of the third hanging parts is formed in a ring shape, and each of the third securing parts is formed with the projection capable being hooked by the third hanging part, and therefore, when the net member is to be used as a partition member, the user just needs to hook the ring parts of the third hanging parts onto the third securing parts constituted by the projections. Thus, in the luggage holding structure according to the above aspect, the user can provide a partition for the trunk by a simple operation.

In the luggage holding structure according to the above aspect, each of the third securing parts and the fourth securing parts is formed in a portion in which the trim is partially recessed.

In the luggage holding structure according to the above aspect, since each of the third securing parts and the fourth securing parts is formed in the portion in which the trim is partially recessed, the third securing parts and the fourth securing parts will not be in the way when luggage is loaded and unloaded in the trunk.

A net member for holding luggage according to one aspect of the present disclosure is a net member for restraining movement of luggage loaded in a trunk of a vehicle. The trunk of the vehicle has first securing parts, second securing parts, third securing parts, and fourth securing parts. The first securing parts are provided as a pair of left and right first securing parts near a floor surface in a front section of the trunk. The second securing parts are provided as a pair of left and right second securing parts near the floor surface in a rear section of the trunk. The third securing parts are provided as a pair of left and right third securing parts on the upper side relative to the first securing parts and the second securing parts in the trunk. The fourth securing parts are provided as a pair of left and right fourth securing parts on the lower side relative to the third securing parts in the trunk.

The net member for holding luggage according to the present aspect is a planar member formed from a foldable material and having lengths in both of a first direction and a second direction orthogonal to the first direction, is expandable at least in the first direction of the first direction and the second direction, and has the first hanging parts, the second hanging parts, and the third hanging parts. The first hanging parts are sections capable being hooked onto the first to the fourth securing parts, and are provided at one end in the first direction on both sides in the second direction. The second hanging parts are sections capable of being hooked onto the first to fourth securing parts, and are provided at another end in the first direction on both sides in the second direction. The third hanging parts are sections capable of being hooked onto the first to fourth securing parts, and are provided at a position between the one end and the other end in the first direction on both sides in the second direction.

Let L1 be a distance between the first securing part and the second securing part on each of left and right of the vehicle, L2 be a distance between the third securing part and the fourth securing part on each of left and right of the vehicle, L3 be a natural length between the first hanging part and the second hanging part in the first direction on each of both sides in the second direction of the net member, and L4 be a natural length between the third hanging part and the second hanging part in the first direction on each of both sides in the second direction of the net member. In this case, the net member for holding luggage according to the present aspect is formed so as to satisfy both relations L3≤L1, and L4≤L2.

In the net member for holding luggage according to the above aspect, the net member has the first hanging parts and the second hanging parts, and is configured to satisfy the relation L3≤L1. Therefore, with the net member for holding luggage according to the present aspect, by placing the net member to cover the luggage from the above in a state in which the luggage is loaded on the floor surface of the trunk, and hooking the first hanging parts and the second hanging part onto the first securing parts and the second securing parts, it is possible to prevent the luggage from moving when, for example, the vehicle is traveling.

Moreover, the net member for holding luggage according to the above aspect is configured to be foldable, and to satisfy the relation L4≤L2. Therefore, with the net member for holding luggage according to the present aspect, it is possible to partition the trunk into front and rear sections by folding the net member in two, hooking the third hanging parts onto the third securing parts, and hooking at least one of the first hanging parts and the second hanging parts onto the fourth securing parts.

Hence, the net member for holding luggage according to the present aspect can be used for both the purpose of holding the luggage loaded on the floor surface, and the purpose of partitioning the trunk into the front and rear sections.

A luggage holding method according to one aspect of the present disclosure is a method using a net member for restraining movement of luggage loaded in a trunk of a vehicle. The trunk of the vehicle has first securing parts, second securing parts, third securing parts, and fourth securing parts. The first securing parts are provided as a pair of left and right first securing parts near a floor surface in a front section of the trunk. The second securing parts are provided as a pair of left and right second securing parts near the floor surface in a rear section of the trunk. The third securing parts are provided as a pair of left and right third securing parts on the upper side relative to the first securing parts and the second securing parts in the trunk. The fourth securing parts are provided as a pair of left and right fourth securing parts on the lower side relative to the third securing parts in the trunk.

The net member is a planar member formed from a foldable material and having lengths in both of a first direction and a second direction orthogonal to the first direction, is expandable at least in the first direction of the first direction and the second direction, and has first hanging parts, second hanging parts, and third hanging parts. The first hanging parts are sections capable being hooked onto the first to the fourth securing parts, and are provided at one end in the first direction on both sides in the second direction. The second hanging parts are sections capable of being hooked onto the first to fourth securing parts, and are provided at another end in the first direction on both sides in the second direction. The third hanging parts are sections capable of being hooked onto the first to fourth securing parts, and are provided at a position between the one end and the other end in the first direction on both sides in the second direction.

Let L1 be a distance between the first securing part and the second securing part on each of left and right of the vehicle, L2 be a distance between the third securing part and the fourth securing part on each of left and right of the vehicle, L3 be a natural length between the first hanging part and the second hanging part in the first direction on each of both sides in the second direction of the net member, and L4 be a natural length between the third hanging part and the second hanging part in the first direction on each of both sides in the second direction of the net member. In this case, the net member is formed so as to satisfy both relations L3≤L1, and L4≤L2.

With the luggage holding method according to the present aspect, when the luggage placed on the floor surface of the trunk is to be held with the net member, the luggage is placed on the floor surface of the trunk, in an area between the first securing parts and the second securing parts in the front-rear direction of the vehicle, and, in a state in which the net member is placed to cover the luggage from above, a pair of the first hanging parts are hooked onto the left and right first securing parts, respectively, and a pair of the second hanging parts are hooked onto the left and right second securing parts, respectively. Moreover, with the luggage holding method according to the present aspect, when the net member is to be used as a partition member to partition the trunk into the front and rear sections, luggage is loaded in at least one of the front section and the rear section of the trunk in the front-rear direction of the vehicle, with respect to a partition formed by folding the net member along a line that connects the third hanging parts to each other, hooking the third hanging parts onto the left and right third securing parts, respectively, and hooking at least one of the first hanging parts and the second hanging parts onto the left and right fourth securing parts, respectively.

In the luggage holding method according to the above aspect, the first hanging parts and the second hanging parts of the net member, and the first securing parts and the second securing parts of the trunk are configured so as to satisfy the relation L3≤L1, and the net member can be used in a mode (first mode) for holding luggage by covering the luggage loaded on the floor surface of the trunk from the above. Thus, by executing the luggage holding method according to the above aspect, it is possible to prevent the luggage loaded on the floor surface from moving when, for example, the vehicle is traveling.

Moreover, in the luggage holding method according to the above aspect, the net member which is foldable and satisfies the relation L4≤L2 with respect to the third securing parts and the fourth securing parts of the trunk is used, and the net member can be used as a partition member to partition the trunk into the front and rear sections (the second mode). Thus, with the luggage holding method according to the above aspect, it is possible to partition the trunk into the front and rear sections by the net member.

Hence, in the luggage holding method according to the above aspect, with the use of a single net member, it is possible to hold the luggage loaded on the floor surface, and also partition the trunk into the front and rear sections.

In each of the above-mentioned aspects, a net member for securing luggage to the trunk of a vehicle can also be used as a partition member for the trunk.

### BRIEF DESCRIPTION OF THE DRAWINGS

FIG. 1 a schematic view showing a trunk of a vehicle to which a luggage holding structure according to an embodiment of the present disclosure is applied.

FIG. 2 is a plan view showing a configuration of a net member for holding luggage.

FIG. 3 is a plan view showing a state in which the net member for holding luggage is folded in a first mode.

FIG. 4 is a plan view showing a state in which the net member for holding luggage is folded in a second mode.

FIG. 5 is a side view showing a specific example of a method of holding luggage in the trunk.

FIG. 6 is a side view showing a specific example of the method of holding luggage in the trunk.

FIG. 7 is a side view showing a specific example of the method of holding luggage in the trunk.

FIG. 8 is a side view showing a specific example of the method of holding luggage in the trunk.

### DETAILED DESCRIPTION

Hereinafter, an embodiment of the present disclosure will be described with reference to the drawings. Note that the embodiment described hereinafter is merely one example of the present disclosure, and the present disclosure is not limited to the following mode except for the inherent configuration thereof.

Moreover, in the drawings used for the following descriptions, “Fr” represents the front side in the vehicle front-rear direction, “Re” represents the rear side in the vehicle front-rear direction, “Up” represents the upper side in the vehicle up-down direction, and “Lo” represents the lower side in the vehicle up-down direction.

1. Structure of Trunk 1b of Vehicle 1

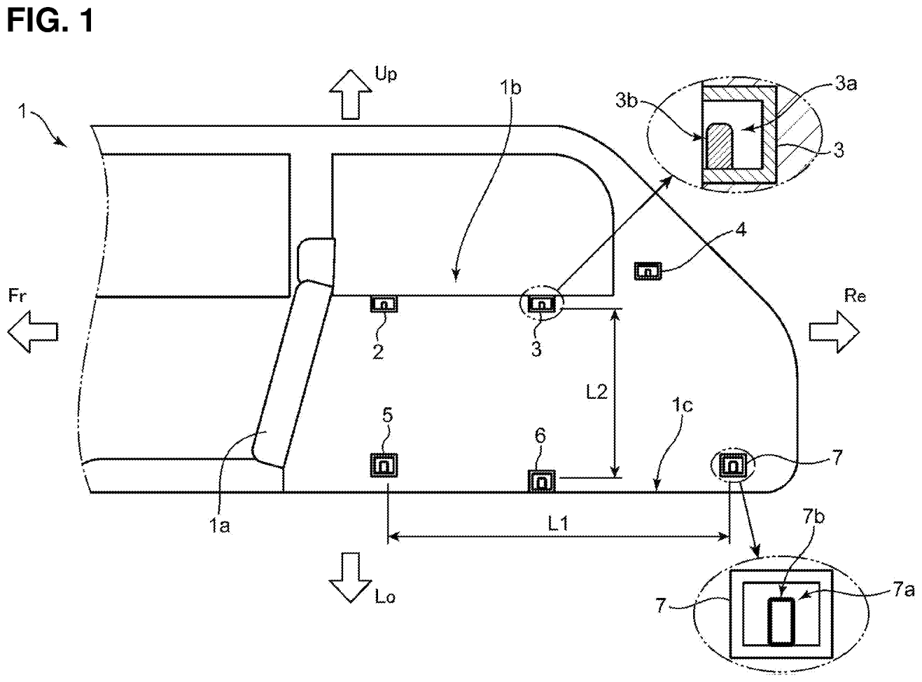

A vehicle holding structure according to the present embodiment is constituted by a combination of a trunk 1b of a vehicle 1 and a net member for holding luggage, and the structure of the trunk 1b will be explained using FIG. 1. Note that FIG. 1 is a schematic view schematically showing the trunk 1b of the vehicle 1, and the sizes and arrangement of parts may be different from actual sizes and arrangement.

As shown in FIG. 1, the vehicle 1 has the trunk 1b provided on the rear side relative to a rear seat 1a. The trunk 1b is provided with securing parts 2 to 7. In FIG. 1, since only the right-side inner surface is illustrated from the inside of the trunk 1b, one part each of the securing parts 2 to 7 is shown, but the securing parts are also provided on the left-side inner surface of the trunk 1b, at symmetrical positions in the vehicle width direction.

The securing parts 2 are provided as a pair of left and right securing parts at middle positions in the up-down direction, in a front section of the trunk 1b. The securing parts (third securing parts) 3 are provided as a pair of left and right securing parts on the rear side relative to the securing parts 2 in the trunk 1b, at positions at substantially the same height as the securing parts 2 in the up-down direction. The securing parts 4 are provided as a pair of left and right securing parts on the further rear side relative to the securing parts 3 in the trunk 1b, at slightly higher positions than the securing parts 2, 3 in the up-down direction.

Each of the securing parts 2, 3, 4 is formed with a projection 3b projecting upward in a recess 3a in which a trim is partially recessed as shown in a partial section of FIG. 1.

The securing parts (first securing parts) 5 are provided as a pair of left and right securing parts near a floor surface 1c in the front section of the trunk 1b. The securing parts (fourth securing parts) 6 are provided as a pair of left and right securing parts near the floor surface 1c, at positions on the rear side relative to the securing parts 5 in the trunk 1b. The securing parts (second securing parts) 7 are provided as a pair of left and right securing parts near the floor surface 1c, at positions on the further rear side relative to the securing parts 6 in the trunk 1b. As shown in a side view in an enlarging portion of FIG. 1, each of the securing parts 5, 6, 7 is formed with a ring part 7b formed in a ring shape in a recess 7a in which the trim is partially recessed.

Here, as shown in FIG. 1, the securing part 5 is located substantially directly below the securing part 2, and the securing part 6 is located substantially directly below the securing part 3.

Note that L1 is the distance between the securing part 5 and the securing part 7 in the front-rear direction of the vehicle 1, and L2 is the distance between the securing part 3 and the securing part 6 in the up-down direction of the vehicle 1.

2. Structure of Net Member 8

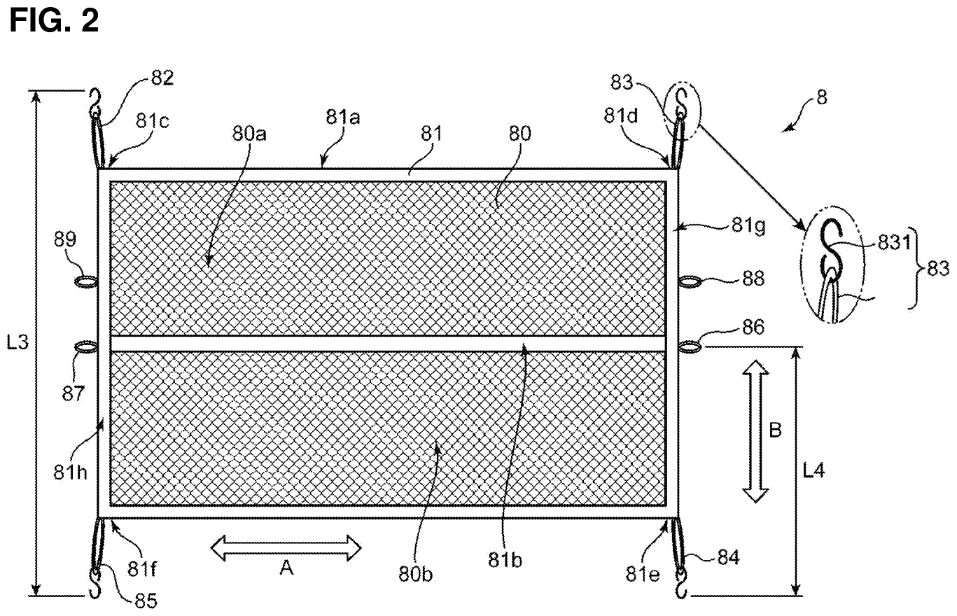

The structure of a net member 8 constituting the luggage holding structure according to the present embodiment will be explained using FIG. 2.

The net member 8 is a member for holding luggage in the trunk 1b of the vehicle 1. As shown in FIG. 2, the net member 8 includes a net body 80 in the form of a net, a band part 81 secured to part of the net body 80, and eight hanging parts 82 to 89. The net body 80 has a rectangular shape in a plan view shown in FIG. 2.

The band part 81 has an outer edge portion 81a secured to an outer edge of the net body 80. Note that the net member 8 is configured to be expandable at least in a direction indicated with an arrow B (first direction) even in a state in which the outer edge portion 81a of the band part 81 is secured to the outer edge of the net body 80, and to be less expandable in a direction indicated with an arrow A (second direction) than in the first direction.

As shown in FIG. 2, the hanging parts 82 to 85 are secured to corners 81c to 81f, respectively, of the band part 81 secured to the outer edge of the net body 80. Moreover, the hanging part 86 is secured to a middle position in a side edge portion 81g of the band part 81, and the hanging part 87 is secured to a middle position in a side edge portion 81h of the band part 81. The hanging part 88 is secured to a position closer to the corner 81d relative to the middle of the side edge portion 81g of the band part 81, and the hanging part 89 is secured to a position closer to the corner 81c relative to the middle of the side edge portion 81h of the band part 81.

As shown in the enlarging portion in FIG. 2, each of the hanging parts 82 to 85 includes a string part 830 in the shape of a ring, and a hook part 831 in the shape of a hook attached to the string part 830. The hook parts 831 of the hanging parts 82 to 85 are formed into a size and shape so as to be able to be hooked onto the ring parts 7b of the securing parts 5 to 7, and onto the projections 3b of the securing parts 2 to 4 in the trunk 1b (see FIG. 1). Note that, in the second direction (direction indicated with arrow A), each of the distance between the hanging part 82 and the hanging part 83, and the distance between the hanging part 84 and the hanging part 85 has a dimension corresponding to the width of the trunk 1b in the vehicle width direction.

Each of the hanging parts 86 to 89 is constituted by a string member formed in the shape of a ring. The hanging parts 86 to 89 are formed into a size and shape so as to be able to be hooked onto the projections 3b of the securing parts 2 to 4 in the trunk 1b (see FIG. 1).

In the net member 8, a pair of the hanging part 82 and the hanging part 83 are applicable to a “first hanging part”, a pair of the hanging part 84 and the hanging part 85 are applicable to a “second hanging part”, and a pair of the hanging part 86 and the hanging part 87 are applicable to a “third hanging part”.

The band part 81 further includes an intermediate portion 81b provided to connect the position in the side edge portion 81g where the hanging part 86 is secured and the position in the side edge portion 81h where the hanging part 87 is secured. The net body 80 is segmented into a first surface portion 80a and a second surface portion 80b with the intermediate portion 81b as a boundary. The function of the intermediate portion 81b will be described later.

Here, in a natural state in which the net member 8 is not expanded in the first direction (direction indicated with arrow B), each of natural lengths (each of the distances in a non-expanded state) between the hanging part 82 and the hanging part 85, and between the hanging part 83 and the hanging part 84, is L3. L3 satisfies the following relation with L1 in the trunk 1b:

L3≤L1. (Expression 1)

Further, in the natural state in which the net member 8 is not expanded in the first direction, each of natural lengths (each of the distances in the non-expanded state) between the hanging part 86 and the hanging part 84, and between the hanging part 87 and the hanging part 85, is L4. L4 satisfies the following relation with L2 in the trunk 1b:

L4≤L2. (Expression 2)

3. Mode of Folding Net Member 8

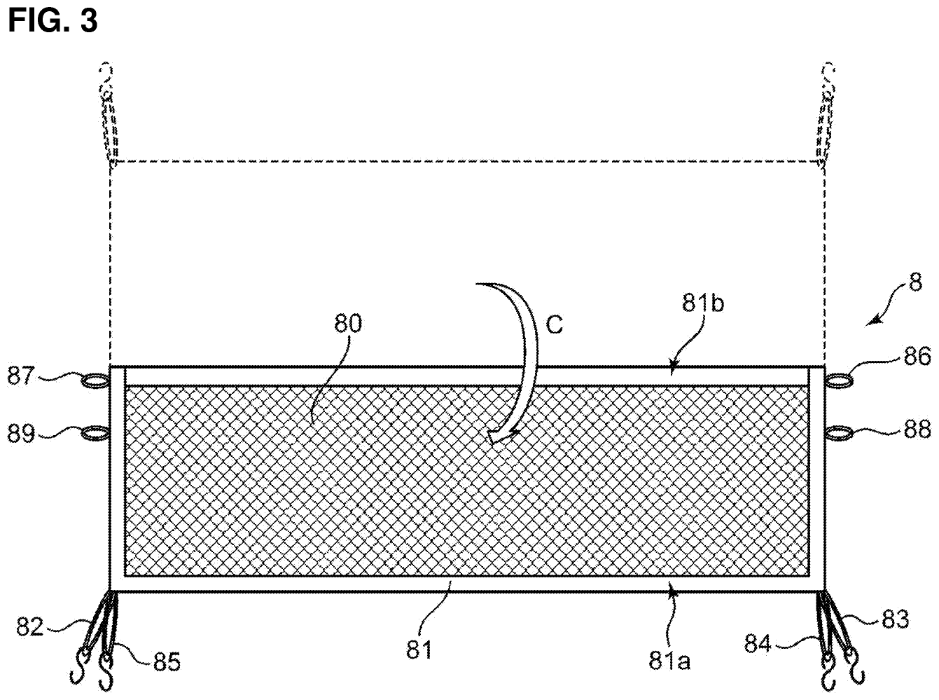

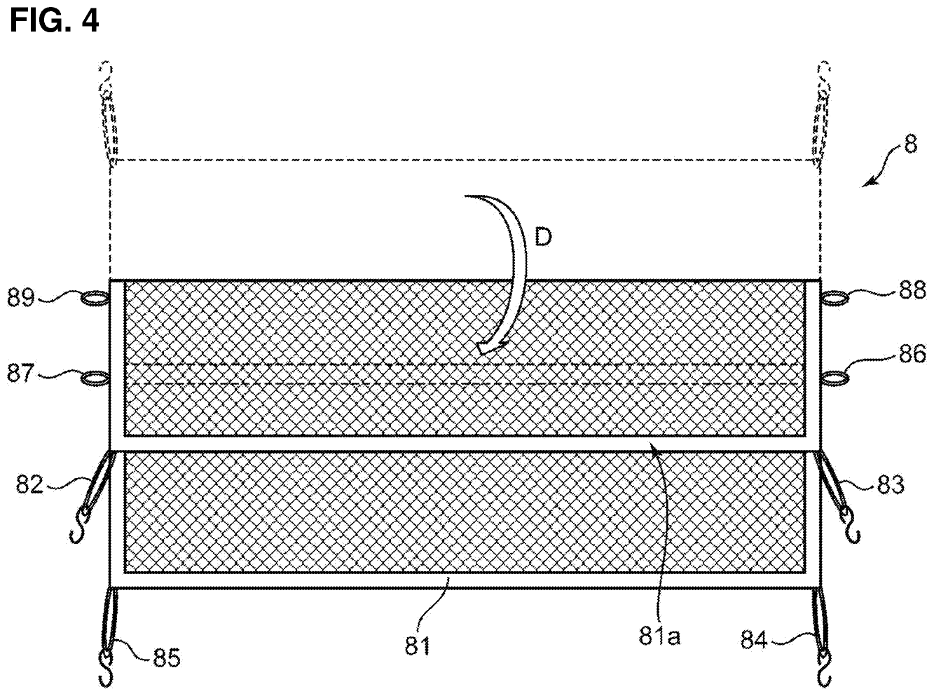

The net member 8 is formed from a foldable material. A mode of folding the net member 8 will be explained using FIG. 3 and FIG. 4.

As shown in FIG. 3, the net member 8 can be folded in two with the intermediate portion 81b as a boundary as shown with an arrow C. In this case, the first surface portion 80a and the second surface portion 80b of the net body 80 are laid one upon another. Note that, as shown in FIG. 3, in the state in which the net member 8 is folded in two, the intermediate portion 81b provided to connect the position where the hanging part 86 is secured and the position where the hanging part 87 is secured has the function of retaining the shape (rectangular shape in the plan view) of the net member 8 in the folded state. In short, the intermediate portion 81b is applicable to a “shape retaining part”.

As shown in FIG. 4, the net member 8 can also be folded along a line connecting the hanging part 88 and the hanging part 89, as a boundary, as shown with an arrow D. In this case, some part of the first surface portion 80a of the net body 80 is laid over some part of the second surface portion 80b.

4. Specific Example of Method of Holding Luggage 500 to Luggage 504 in Trunk 1b

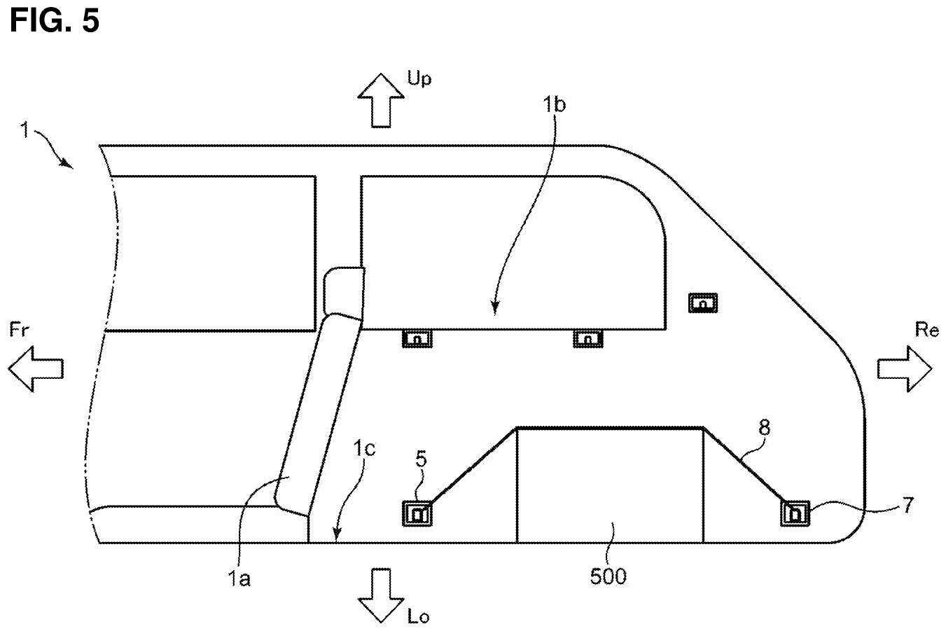

A specific example of a method of holding luggage 500 to luggage 504 in the trunk 1b will be explained using FIG. 5 to FIG. 8.

(First Mode)

As shown in FIG. 5, the method of holding the luggage 500 according to a first mode is implemented through the following steps:

1-1 Step—The luggage 500 is placed on the floor surface 1c in the trunk 1b. At this time, the luggage 500 is arranged in an area between the securing parts 5 and the securing parts 7 in the front-rear direction of the vehicle 1.

1-2 Step—Next, a user places the net member 8 to cover the luggage 500 from the above. In this case, the user makes the net member 8 in an expanded state as shown in FIG. 2, and arranges the net member 8 to align the expandable first direction (the direction indicated with arrow B in FIG. 2) with the front-rear direction of the vehicle 1.

1-3 Step—Subsequently, the user hooks the hanging parts 82, 83 of the net member 8 onto the left and right securing parts 5, respectively. Note that the luggage 500 may be stored in the trunk 1b after hooking the hanging parts 82, 83 onto the securing parts 5.

1-4 Step—Finally, the user hooks the hanging parts 84, 85 of the net member 8 to the left and right securing parts 7, respectively, as shown in FIG. 5, thereby completing holding the luggage 500 in the trunk 1b.

(Second Mode)

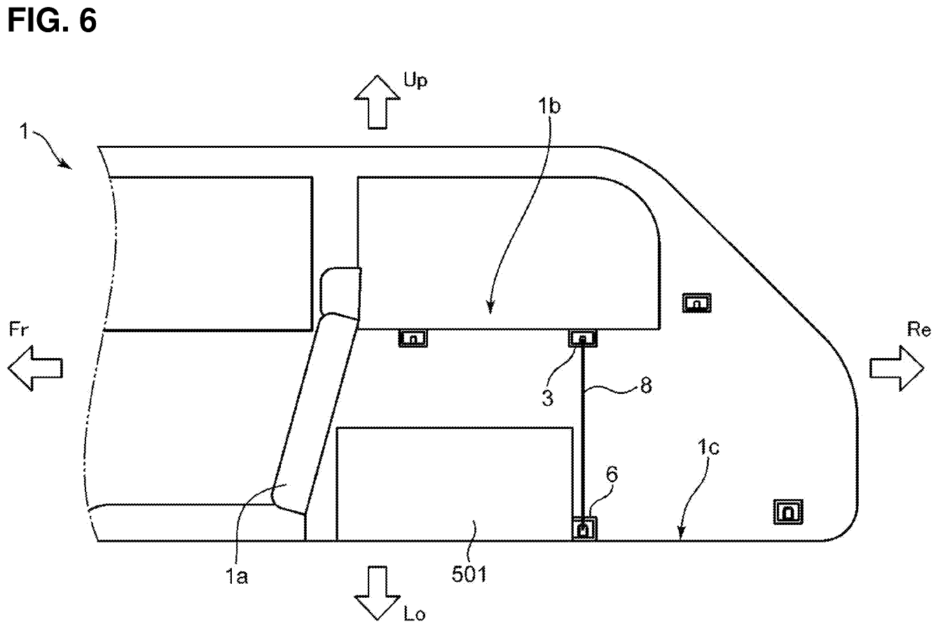

As shown in FIG. 6, the method of holding the luggage 501 according to a second mode is implemented through the following steps:

2-1 Step—The luggage 501 is placed on the floor surface 1c in the trunk 1b. At this time, the luggage 501 is arranged in an area on the front side relative to the securing parts 6 in the front-rear direction of the vehicle 1.

2-2 Step—Next, the user folds the net member 8 in two as shown in FIG. 3.

2-3 Step—Subsequently, the user hooks the hanging parts 86, 87 of the net member 8 onto the left and right securing parts 3, respectively. Note that, in this case, since the net member 8 has the intermediate portion 81b (see FIG. 2 and FIG. 3), the net member 8 will not become slack in the vehicle width direction.

2-4 Step—Finally, the user makes the net member 8 in a state being tensioned in the first direction (the direction indicated with arrow B in FIG. 2) as shown in FIG. 6, and hooks at least one of the hanging parts 82, 83 and the hanging parts 84, 85 onto the left and right securing parts 6, thereby providing a partition in the trunk 1b, and completing holding the luggage 501 in the trunk 1b with the net member 8 serving as the partition.

Note that, in the present specific example, in order to place the luggage 501 on the front side relative to the net member 8 serving as the partition, first, the luggage 501 is stored in the trunk 1b, and then the partition is provided in the trunk 1b, but, if the location where the luggage 501 is to be placed is on the rear side in the trunk 1b, the luggage 501 is stored in the trunk 1b after providing the partition with the use of the net member 8.

(Third Mode)

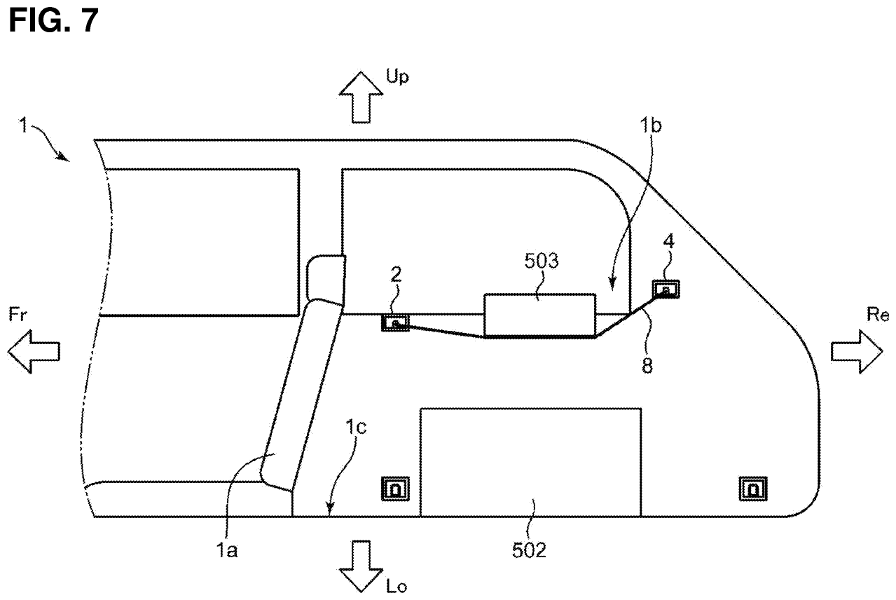

As shown in FIG. 7, the method of holding the luggage 502, 503 according to a third mode is implemented through the following steps:

3-1 Step—The luggage 502 of a relatively large size is placed on the floor surface 1c in the trunk 1b.

3-2 Step—Next, the user makes the net member 8 in an expanded state shown in FIG. 2, and hooks the hanging parts 82, 83 of the net member 8 onto the left and right securing parts 2, respectively.

3-3 Step—Subsequently, the user hooks the hanging parts 84, 85 of the net member 8 onto the left and right securing parts 4, respectively. Note that, in this case, considering the weight of the luggage 503 to be placed on the net member 8, it is also possible to hook the hanging parts 86, 87 or the hanging parts 88, 89 onto the securing parts 3 (see FIG. 1).

3-4 Step—Finally, the user places the luggage 503 of a relatively small size on the net member 8 as shown in FIG. 7, thereby completing holding the luggage 502, 503 in the trunk 1b.

Note that, in the present specific example, although the example in which two pieces of luggage 502, 503 are held in the trunk 1b is employed, it is possible to use the net member 8 in the mode as shown in FIG. 7 to hold one piece of luggage. That is, in a case where luggage in a spherical shape or the like that rolls easily is to be held in the trunk, it is possible to prevent the luggage from rolling and moving to the front, rear, left and right in the trunk by placing the luggage on the net member stretched as shown in FIG. 7.

(Fourth Mode)

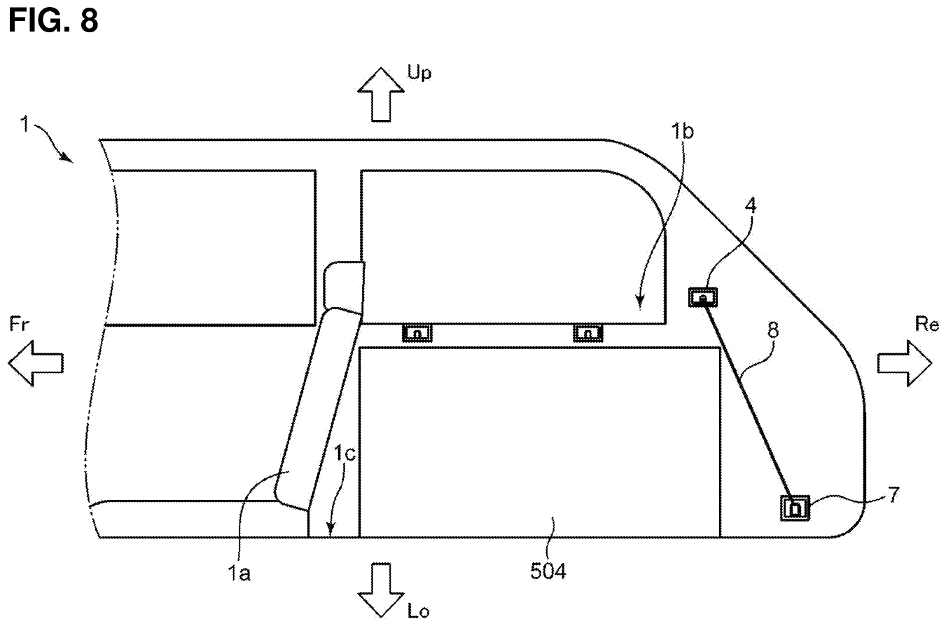

As shown in FIG. 8, the method of holding the luggage 504 according to a fourth mode is implemented through the following steps:

4-1 Step—The luggage 504 is placed on the floor surface 1c in the trunk 1b. At this time, the luggage 504 is arranged in an area on the front side relative to the securing parts 7 in the front-rear direction of the vehicle 1.

4-2 Step—Next, the user folds the net member 8 into the state shown in FIG. 4.

4-3 Step—Subsequently, the user hooks the hanging parts 88, 89 of the net member 8 onto the left and right securing parts 4, respectively.

4-4 Step—Finally, the user makes the net member 8 in a state being tensioned in the first direction (the direction indicated with arrow B in FIG. 2) as shown in FIG. 8, and hooks the hanging parts 84, 85 onto the left and right securing parts 7, thereby providing a partition on the rear side relative to the luggage 504 in the trunk 1b, and completing holding the luggage 504 in the trunk 1b with the net member 8 serving as the partition. Consequently, it is possible to prevent the luggage 504 from moving to the rear side and colliding with a rear gate when, for example, the vehicle 1 is traveling.

5. Effects

In the luggage holding structure, the net member for holding luggage, and the luggage holding method according to the present embodiment, the net member 8 has one pair of the hanging parts 82, 83, and one pair of the hanging parts 84, 85, and is configured to satisfy the relation of Expression 1 described above. Thus, with the luggage holding structure, the net member for holding luggage, and the luggage holding method according to the present embodiment, by placing the net member 8 to cover the luggage 500 from the above in the state in which the luggage 500 is placed on the floor surface 1c in the trunk 1b, and hooking the hanging parts 82, 83 onto the securing parts 5 and hooking the hanging parts 84, 85 onto the securing parts 7, it is possible to prevent the luggage 500 from moving when, for example, the vehicle 1 is traveling (the first mode shown in FIG. 5).

Moreover, in the luggage holding structure, the net member for holding luggage, and the luggage holding method according to the present embodiment, a material that is foldable as shown in FIG. 3 is used as the net member 8, and is configured to satisfy Expression 2 described above. Thus, with the luggage holding structure, the net member for holding luggage, and the luggage holding method according to the present embodiment, by folding the net member 8 in two, hooking the hanging parts 86, 87 onto the securing parts 3, and hanging at least one pair of the hanging parts 82, 83 and the hanging parts 84, 85 onto the securing parts 6, it is possible to partition the trunk 1b into front and rear sections with the net member 8 (the second mode shown in FIG. 6).

Consequently, with the luggage holding structure, the net member for holding luggage, and the luggage holding method according to the present embodiment, a single net member 8 can be used for both the purpose of holding the luggage 500 placed on the floor surface 1c in the trunk 1b, and the purpose of partitioning the trunk 1b into the front and rear sections.

According to the present embodiment, the net member 8 is formed so as to be more easily expandable in the first direction (the direction indicated with arrow B in FIG. 2) compared to the second direction (the direction indicated with arrow A in FIG. 2) along the vehicle width direction when the net member 8 is attached to the trunk 1b. In other words, the net member 8 is formed so as not to expand easily in the second direction compared to the first direction. Therefore, as shown in FIG. 3, in the case where the net member 8 is folded in two and used as the partition member, the amount of expansion of the net member 8 in the vehicle width direction can be made relatively small, which is preferred to make the net member 8 reliably function as the partition member.

According to the present embodiment, the net member 8 has a rectangular shape in the plan view as shown in FIG. 2, and therefore, even when the net member 8 is folded in two as shown in FIG. 3, the net member 8 is rectangular in shape. Hence, in the case where the net member 8 is to be used as the partition member, it is possible to reduce occurrence of a gap between the net member 8 and the left and right trims enclosing the trunk 1b.

According to the present embodiment, the net member 8 has the intermediate portion (shape retaining part) 81b to connect the hanging parts 86 and the hanging parts 87, and therefore, when the net member 8 is folded in two as shown in FIG. 3 and is used as the partition member, it is less likely that the net member 8 is deformed in shape and does not sufficiently function as the partition member.

In the luggage holding structure according to the present embodiment, the net member 8 has the hook part 831 at the distal end portion of each of the hanging parts 82 to 85, and each of the securing parts 5 to 7 of the trunk 1b of the vehicle 1 has the ring part 7b, and therefore the net member 8 can be secured to the trunk 1b by just hooking the hook parts 831 onto the ring parts 7b of the securing parts 5 to 7. Consequently, with the luggage holding structure and the luggage holding method according to the present embodiment, the user can secure the net member 8 to the trunk 1b by a simple operation.

In the luggage holding structure according to the present embodiment, each of the hanging parts 86 to 89 of the net member 8 is formed in a ring shape, and the securing parts 2 to 4 of the trunk 1b of the vehicle 1 are formed with the projections 3b onto which the respective hanging parts 86 to 89 can be hooked, and therefore, when the net member 8 is to be used as the partition member, the user just needs to hook the ring parts constituting the hanging parts 86 to 89 onto the projections 3b of the securing parts 2 to 4. Consequently, with the luggage holding structure and the luggage holding method according to the present embodiment, the user can install the partition in the trunk 1b by a simple operation.

With the luggage holding structure according to the present embodiment, in the trunk 1b of the vehicle 1, since each of the securing parts 2 to 7 are formed in portions (recesses 3a, 7a) in which the trims are partially recessed, the securing parts 2 to 7 will not be in the way when the luggage 500 to luggage 504 are loaded and unloaded in the trunk 1b.

In the above embodiment, although the net member 8 that is hard to expand in the second direction relative to the first direction is employed, the present disclosure is not limited to this. For example, it is possible to employ a net member which is expandable to the same degree both in the first direction and the second direction.

In the above embodiment, although the net member having a rectangular shape in the plan view is employed, the present disclosure is not limited to this. For example, it is possible to employ a net member in the shape of a rounded rectangle or polygon, or it is possible to employ an oval-shaped net member.

In the net member 8 according to the above embodiment, the hanging part having the hook part 831 at the distal end portion is used as each of the hanging parts 82 to 85, and the ring-shaped hanging part is used as each of the hanging parts 86 to 89, but the present disclosure is not limited to this. For example, it is possible to suitably form hanging parts having hook parts, and ring-shaped hanging parts, or it is possible to form all the hanging parts as hanging parts having the hook parts, or ring-shaped hanging parts.

In the luggage holding structure according to the above embodiment, although six pairs of securing parts 2 to 7 are provided in the trunk 1b of the vehicle 1, the present disclosure is not limited to this. The number and locations of securing parts to be formed in the trunk 1b can be suitably set.

In the luggage holding structure according to the above embodiment, although the securing parts 2 to 7 are provided in such a manner that the trims of the trunk 1b are partially recessed, the present disclosure is not limited to this. For example, it is possible to employ securing parts projecting from the trims into the trunk.

In the net member 8 according to the above embodiment, although the size is set so that the natural length L4 in the state of being folded in two is about ½ of the natural length L3 in the state being expanded without being folded, the present disclosure is not limited to this. For example, it is possible to set the size to satisfy L4<L3/2, or L4>L3/2.

What is claimed is:

1. A luggage holding structure using a net member for restraining movement of luggage loaded in a trunk of a vehicle, wherein,
the trunk of the vehicle has:
a pair of left and right first securing parts provided near a floor surface in a front section of the trunk;
a pair of left and right second securing parts provided near the floor surface in a rear section of the trunk;
a pair of left and right third securing parts provided on an upper side relative to the first securing parts and the second securing parts in the trunk; and
a pair of left and right fourth securing parts provided on a lower side relative to the third securing parts in the trunk,
the net member is a planar member comprising a foldable material and having lengths in both of a first direction and a second direction orthogonal to the first direction,
the net member is expandable at least in the first direction of the first direction and the second direction,
the net member has:
first hanging parts capable of being hooked onto the first to fourth securing parts, the first hanging parts being provided at one end in the first direction on both sides in the second direction;
second hanging parts capable of being hooked onto the first to fourth securing parts, the second hanging parts being provided at another end in the first direction on both sides in the second direction; and
third hanging parts capable of being hooked onto the first to fourth securing parts, the third hanging parts being provided at a position between the one end and the other end in the first direction on both sides in the second direction, and
the net member satisfies both relations L3≤L1, and L4≤L2, where
L1 is a distance between the first securing part and the second securing part on each of left and right of the vehicle,
L2 is a distance between the third securing part and the fourth securing part on each of left and right of the vehicle,
L3 is a natural length between the first hanging part and the second hanging part in the first direction on each of both sides in the second direction of the net member, and
L4 is a natural length between the third hanging part and the second hanging part in the first direction on each of both sides in the second direction of the net member.

2. The luggage holding structure according to claim 1, wherein the net member is more easily expandable in the first direction than the second direction.

3. The luggage holding structure according to claim 2, wherein the net member has a rectangular shape in a plan view of the net member viewed from a direction orthogonal to both the first direction and the second direction.

4. The luggage holding structure according to claim 3, wherein the net member further has a shape retaining part oriented in the second direction to connect the third hanging parts to each other, and to retain a folded shape when the net member is folded along a line connecting the third hanging parts to each other.

5. The luggage holding structure according to claim 4, wherein
each of the first hanging parts and the second hanging parts has a hook part in a hooked shape at a distal end portion, and
each of the first securing parts, the second securing parts, and the fourth securing parts has a ring shape capable of being hooked by the hook part.

6. The luggage holding structure according to claim 5, wherein
at least a distal end portion of each of the third hanging parts has a ring shape, and
each of the third securing parts has a projection projecting upward so as to be able to be hooked by the third hanging part.

7. The luggage holding structure according to claim 6, wherein each of the third securing parts and the fourth securing parts is disposed in a portion in which a trim is partially recessed.

8. The luggage holding structure according to claim 1, wherein the net member has a rectangular shape in a plan view of the net member viewed from a direction orthogonal to both the first direction and the second direction.

9. The luggage holding structure according to claim 1, wherein the net member further has a shape retaining part oriented in the second direction to connect the third hanging parts to each other, and to retain a folded shape when the net member is folded along a line connecting the third hanging parts to each other.

10. The luggage holding structure according to claim 1, wherein
each of the first hanging parts and the second hanging parts has a hook part in a hooked shape at a distal end portion, and
each of the first securing parts, the second securing parts, and the fourth securing parts has a ring shape capable of being hooked by the hook part.

11. The luggage holding structure according to claim 1, wherein
at least a distal end portion of each of the third hanging parts has a ring shape, and
each of the third securing parts has a projection projecting upward so as to be able to be hooked by the third hanging part.

12. The luggage holding structure according to claim 1, wherein each of the third securing parts and the fourth securing parts is disposed in a portion in which a trim is partially recessed.

13. A net member for holding luggage for restraining movement of luggage loaded in a trunk of a vehicle, the trunk having a pair of left and right first securing parts provided near a floor surface in a front section of the trunk; a pair of left and right second securing parts provided near the floor surface in a rear section of the trunk; a pair of left and right third securing parts provided on an upper side relative to the first securing parts and the second securing parts in the trunk; and a pair of left and right fourth securing parts provided on a lower side relative to the third securing parts in the trunk, wherein
the net member is a planar member comprising a foldable material and having lengths in both of a first direction and a second direction orthogonal to the first direction,
the net member is expandable at least in the first direction of the first direction and the second direction,
the net member has:
first hanging parts capable of being hooked onto the first to fourth securing parts, the first hanging parts being provided at one end in the first direction on both sides in the second direction;
second hanging parts capable of being hooked onto the first to fourth securing parts, the second hanging parts being provided at another end in the first direction on both sides in the second direction; and
third hanging parts capable of being hooked onto the first to fourth securing parts, the third hanging parts being provided at a position between the one end and the other end in the first direction on both sides in the second direction, and
the net member satisfies both relations L3≤L1, and L4≤L2, where
L1 is a distance between the first securing part and the second securing part on each of left and right of the vehicle,
L2 is a distance between the third securing part and the fourth securing part on each of left and right of the vehicle,
L3 is a natural length between the first hanging part and the second hanging part in the first direction on each of both sides in the second direction of the net member, and
L4 is a natural length between the third hanging part and the second hanging part in the first direction on each of both sides in the second direction of the net member.

14. A luggage holding method using a net member for restraining movement of luggage loaded in a trunk of a vehicle, wherein the trunk of the vehicle has:
a pair of left and right first securing parts provided near a floor surface in a front section of the trunk;
a pair of left and right second securing parts provided near the floor surface in a rear section of the trunk;
a pair of left and right third securing parts provided on an upper side relative to the first securing parts and the second securing parts in the trunk; and
a pair of left and right fourth securing parts provided on a lower side relative to the third securing parts in the trunk,
the net member is a planar member comprising a foldable material and having lengths in both of a first direction and a second direction orthogonal to the first direction,
the net member is expandable at least in the first direction of the first direction and the second direction,
the net member has:
first hanging parts capable of being hooked onto the first to fourth securing parts, the first hanging parts being provided at one end in the first direction on both sides in the second direction;
second hanging parts capable of being hooked onto the first to fourth securing parts, the second hanging parts being provided at another end in the first direction on both sides in the second direction; and
third hanging parts capable of being hooked onto the first to fourth securing parts, the third hanging parts being provided at a position between the one end and the other end in the first direction on both sides in the second direction, and
the net member satisfies both relations L3≤L1, and L4≤L2, where
L1 is a distance between the first securing part and the second securing part on each of left and right of the vehicle,
L2 is a distance between the third securing part and the fourth securing part on each of left and right of the vehicle,
L3 is a natural length between the first hanging part and the second hanging part in the first direction on each of both sides in the second direction of the net member, and
L4 is a natural length between the third hanging part and the second hanging part in the first direction on each of both sides in the second direction of the net member,
the luggage holding method comprising:
when the luggage placed on the floor surface of the trunk is to be held with the net member, placing the luggage on the floor surface of the trunk, in an area between the first securing parts and the second securing parts in a front-rear direction of the vehicle, and, in a state in which the net member is placed to cover the luggage from above, hooking a pair of the first hanging parts onto the left and right first securing parts, respectively, and hooking a pair of the second hanging parts onto the left and right second securing parts, respectively; and
when the net member is to be used as a partition member to partition the trunk into the front and rear sections, loading the luggage in at least one of the front section and the rear section of the trunk in a front-rear direction of the vehicle, with respect to a partition formed by folding the net member along a line that connects the third hanging parts to each other, hooking the third hanging parts onto the left and right third securing parts, respectively, and hooking at least one of the first hanging parts and the second hanging parts onto the left and right fourth securing parts, respectively.
